(19) United States
(12) Patent Application Publication
(10) Pub. No.: US 2025/0244760 A1
(43) Pub. Date: Jul. 31, 2025

(54) SYSTEM FOR SELECTING MANEUVERS BASED ON TELEOPERATION AND NETWORK RESOURCES

(71) Applicant: TOYOTA MOTOR ENGINEERING & MANUFACTURING NORTH AMERICA, INC., PLANO, TX (US)

(72) Inventors: XUNBI JI, Mountain View, CA (US); Sergei S. Avedisov, Mountain View, CA (US); Mohammad Irfan Khan, Mountain View, CA (US); Onur Altintas, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/424,308

(22) Filed: Jan. 26, 2024

(51) Int. Cl. G05D 1/222

(52) U.S. Cl. CPC G05D 1/222

(57) ABSTRACT

Systems and methods are provided for selecting maneuvers for teleoperation of a vehicle. The system can determine a set of maneuvers associated with a teleoperated vehicle and determine latencies between each of the set of maneuvers and the teleoperated vehicle. A preferred maneuver can be selected from the set of maneuvers. The system can determine that the preferred maneuver satisfies a critical condition based on the latency between the preferred maneuver and the teleoperated vehicle and perform the preferred maneuver using the teleoperated vehicle.

### TECHNICAL FIELD

The present disclosure relates generally to the remote teleoperation of vehicles, and in particular, some embodiments relate to the latencies involved in executing remote operating tasks.

### DESCRIPTION OF RELATED ART

Teleoperated driving allows a remote operator (human or automated control algorithm) to control the motion of a vehicle without physically being in a vehicle. In order to accomplish this task, the ego vehicle being remotely driven transmits sensor information such as camera data, lidar, and radar data to the remote operator, referred to as an uplink. The remote operator processes this information and then uses it to prescribe either a trajectory or commands to the remote operator, known as a downlink. The performance of the teleoperated driving system is correlated to the age of information in the control loop, which relates to how frequently sensor data is transmitted to the remote operator, how frequently the data is translated to control commands by the remote operator, and how frequently commands are transmitted to the vehicle.

### BRIEF SUMMARY OF THE DISCLOSURE

According to various embodiments of the disclosed technology, a method can comprise determining a set of maneuvers associated with a teleoperated vehicle; determining latencies between each of the set of maneuvers and the teleoperated vehicle; selecting a preferred maneuver from the set of maneuvers; determining that the preferred maneuver satisfies a critical condition based on the latency between the preferred maneuver and the teleoperated vehicle; and performing the preferred maneuver using the teleoperated vehicle.

In some embodiments, determining latencies is based on an actuation time for the teleoperated vehicle.

In some embodiments, determining latencies comprises determining uplink latencies, downlink latencies, and processing time for each of the set of maneuvers.

In some embodiments, the processing time includes a remote operator reaction time.

In some embodiments, the critical condition comprises path, curvature, speed, or vehicle parameters.

In some embodiments, selecting the preferred maneuver is based on a predefined preference parameter.

In some embodiments, the predefined preference parameter is set based on user input.

In some embodiments, the predefined preference parameter comprises fueling or battery charge.

According to various embodiments of the disclosed technology, a system for remote teleoperation of a vehicle can comprise a processor and a memory coupled to the processor to store instructions. These instructions, when executed by the processor, can cause the processor to determine a set of maneuvers associated with a teleoperated vehicle; determine latencies between each of the set of maneuvers and the teleoperated vehicle; select a preferred maneuver from the set of maneuvers based on a predefined preference parameter; determine that the preferred maneuver does not satisfy a critical condition based on the latency between the preferred maneuver and the teleoperated vehicle; select a next preferred maneuver from the set of maneuvers based on the predefined preference parameter; and perform the next preferred maneuver using the teleoperated vehicle.

In some embodiments, determining latencies is based on an actuation time for the teleoperated vehicle.

In some embodiments, determining latencies comprises determining uplink latencies, downlink latencies, and processing time for each of the set of maneuvers.

In some embodiments, the processing time includes a remote operator reaction time.

In some embodiments, the critical condition comprises path, curvature, speed, or vehicle parameters.

In some embodiments, the predefined preference parameter is set based on user input.

In some embodiments, the predefined preference parameter comprises fueling or battery charge.

According to various embodiments of the disclosed technology, a non-transitory machine-readable medium can have instructions stored therein. These instructions, when executed by a processor, can cause the processor to determine a set of maneuvers associated with a teleoperated vehicle; determine latencies between each of the set of maneuvers and the teleoperated vehicle; select a preferred maneuver from the set of maneuvers based on a predefined preference parameter; determine that the preferred maneuver does not satisfy a critical condition based on the latency between the preferred maneuver and the teleoperated vehicle; determine that no other maneuvers in the set of maneuvers satisfy the predefined preference parameter; and request assistance from a remote operator to operate the teleoperated vehicle.

In some embodiments, determining latencies comprises determining uplink latencies, downlink latencies, and processing time for each of the set of maneuvers.

In some embodiments, the processing time includes a remote operator reaction time.

In some embodiments, the critical condition comprises path, curvature, speed, or vehicle parameters.

In some embodiments, the predefined preference parameter comprises fueling or battery charge.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3A illustrates an example architecture for selecting teleoperator maneuvers in accordance with one embodiment of the systems and methods described herein.

FIG. 3B illustrates an example flow chart incorporating the architecture described in FIG. 3A.

FIG. 4A illustrates an example scenario incorporating the embodiments described herein.

FIG. 4B illustrates another example scenario incorporating the embodiments described herein.

FIG. 5 illustrates an example method in accordance with the embodiments described herein.

FIG. 6 is an example computing component that may be used to implement various features of embodiments described in the present disclosure.

The figures are not exhaustive and do not limit the present disclosure to the precise form disclosed.

### DETAILED DESCRIPTION

The performance of a teleoperated driving system is correlated to the age of information in the control loop, meaning that adjusting the frequency information is transmitted can negatively or positively affect the performance of the teleoperated driving system. On one hand, transmitting sensor data/commands infrequently may lead to poor performance of the system due to the outdated information. On the other hand, transmitting too frequently may congest the wireless channel, which can result in poor service quality. Furthermore, the performance of the teleoperated driving system is related to the processing delay, i.e., how much time it takes for the processor or human operator to determine the appropriate action. The processing delay may be related to the load on the remote operator. For example, if the remote operator needs to perform multiple tasks simultaneously, the corresponding latency may be large.

Here, latency can refer to anything delaying the actuation of a remote driving maneuver, including, but not limited to, the time to create torque when commanded, the time to assign commands to the vehicle, the processing time for the remote operator, the time to communicate images or other sensor information from the vehicle to the teleoperator, and/or the time to send commands back to the vehicle after transmitting sensor information to the remote operator. Different maneuvers have different tolerances for latency. For example, a maneuver requiring higher velocities and sharper steering angles may have a lower tolerance for latency compared to a low-speed maneuver with less steering. Therefore, selecting the proper maneuver while taking into consideration these latencies can be critical for successful remote driving tasks.

The systems and methods described herein automate this selection process with the intention of improving the safety of remote driving maneuvers in consideration of the remote operator. The system can select an optimal maneuver among maneuver candidates based on relevant properties and parameters of the given remote operator, including the network configuration, type of the operator and the parallel tasks which may occupy the same network channel and remote processor. This system can analyze the transmitting rates of the uplink and downlink, the processing rate of the remote processor, the vehicle configuration (including actuation time), and multiple maneuver candidates to select one of the maneuver candidates or request assistance from other remote operators.

The system can differentiate between remote operators and take into account the varying tolerances and/or latencies associated with different types of remote operators. This analysis can assist the system in choosing a type of remote operator where necessary. Regardless of the remote operator, the system can evaluate whether a remote driving maneuver satisfies a predefined preference parameter and/or a critical condition. Here, a predefined preference parameter refers to any preference in selecting a maneuver outside of latency configurations. This preference parameter may be set by a client user for example. Example preferences can include, but are not limited to selecting maneuvers based on the battery or fueling of the corresponding vehicle, type of vehicle, fuel cost, etc.

On the other hand, the critical condition refers to a parameter that must be met and can be affected by latency considerations. For example, a critical condition may be the strong curvature of a turn required to effectuate the maneuver. Because of the strong curvature, there may be a lower latency tolerance associated with the maneuver, as opposed to a maneuver with no curvature, which may have a higher latency tolerance based on the complexity of the maneuver. The system can determine that the selected maneuver and the evaluated latency satisfies the critical condition before proceeding with the remote operating task. In the event that the available maneuvers cannot satisfy the critical condition, the remote operator may seek assistance from another remote operator which may have lower latencies to satisfy the critical condition. The other remote operator can then successfully complete the remote operating task.

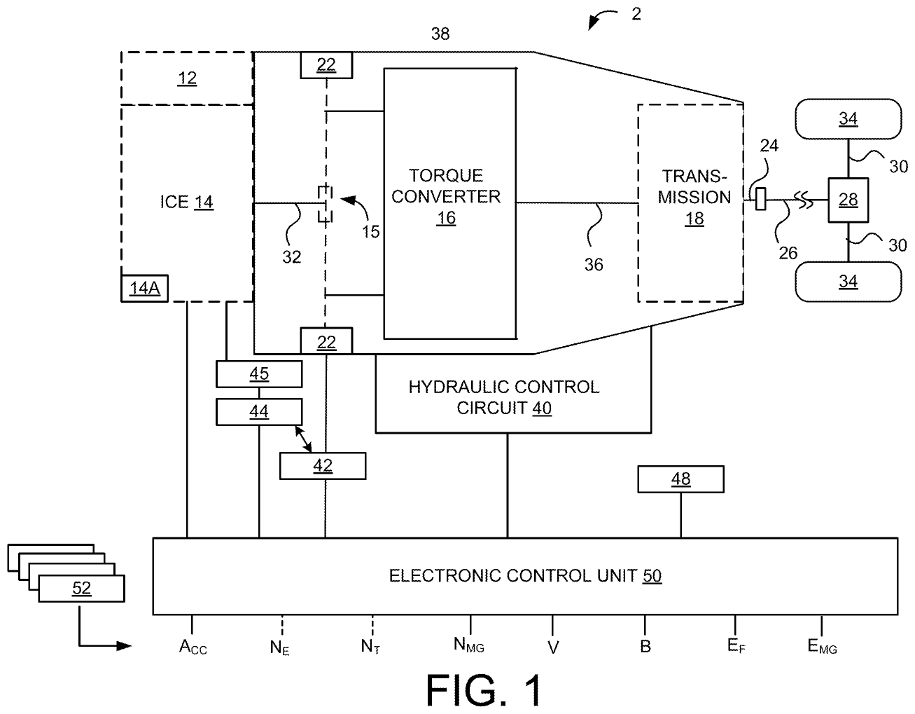

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for driver style detection and mitigation can be implemented in other types of vehicles including gasoline-or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG,}hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

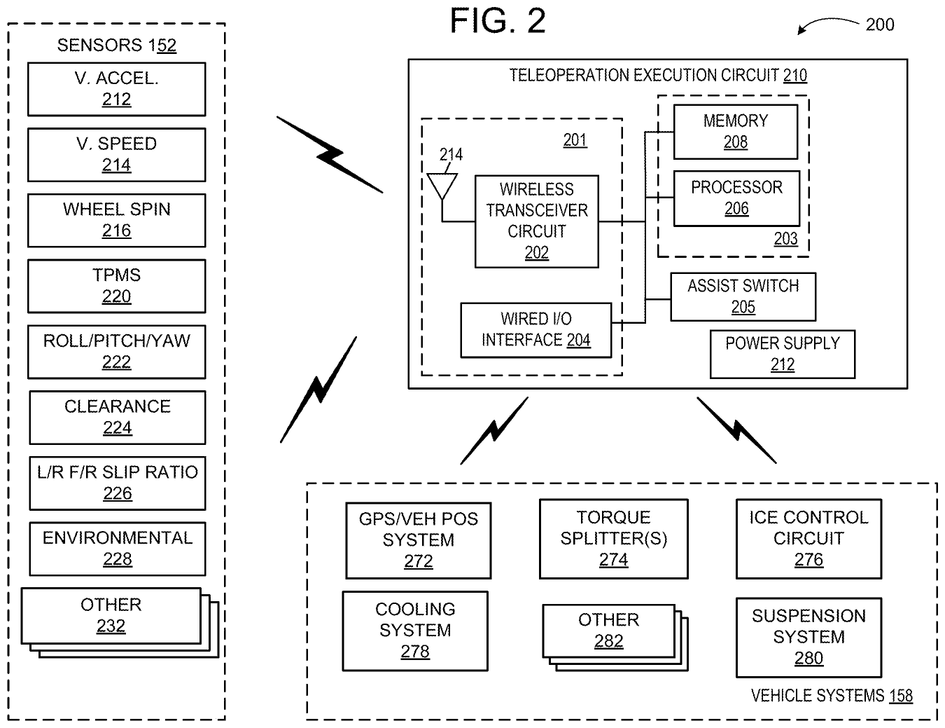

FIG. 2 illustrates an example architecture for teleoperation execution in accordance with one embodiment of the systems and methods described herein. In some embodiments, teleoperation execution system 200 can be implemented in-vehicle to execute while a driver is operating the vehicle. In other embodiments, teleoperation execution system 200 can operate over a cloud or other network. Referring now to FIG. 2, in this example, teleoperation execution system 200 includes a teleoperation execution circuit 210, a plurality of sensors 152 and a plurality of vehicle systems 158.

Sensors 152 and vehicle systems 158 can communicate with teleoperation execution circuit 210 via a wired or wireless communication interface. Although sensors 152 and vehicle systems 158 are depicted as communicating with teleoperation execution circuit 210, they can also communicate with each other as well as with other vehicle systems. In embodiments where teleoperation execution circuit 210 is implemented in-vehicle, teleoperation execution circuit 210 can be implemented as an ECU or as part of an ECU such as, for example electronic control unit 50. In other embodiments, teleoperation execution circuit 210 can be implemented independently of the ECU, such that sensors 152 and vehicle systems 158 can communicate to teleoperation execution circuit 210 over a network, server or cloud interface. In embodiments where teleoperation execution circuit 210 operates over a network, teleoperation execution circuit 210 can receive teleoperations from a remote operator and communicate back to sensors 152 and vehicle systems 158.

Teleoperation execution circuit 210 in this example includes a communication circuit 201, a decision circuit 203 (including a processor 206 and memory 208 in this example) and a power supply 212. Components of teleoperation execution circuit 210 are illustrated as communicating with each other via a data bus, although other communication in interfaces can be included. Processor 206 can include one or more GPUs, CPUs, microprocessors, or any other suitable processing systems. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to teleoperation execution circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a driver style detection circuit 210.

Communication circuit 201 can comprise either or both a wireless transceiver circuit 202 with an associated antenna 205 and a wired I/O interface 204 with an associated hardwired data port (not illustrated). Communication circuit 201 can provide for V2X and/or V2V communications capabilities, allowing teleoperation execution circuit 210 to communicate with edge devices, such as roadside unit/equipment (RSU/RSE), network cloud servers and cloud-based databases, and/or other vehicles via a network. For example, V2X communication capabilities allows teleoperation execution circuit 210 to communicate with edge/cloud devices, roadside infrastructure (e.g., such as roadside equipment/roadside unit, which may be a vehicle-to-infrastructure (V2I)-enabled streetlight or cameras, for example), etc. Local teleoperation execution circuit 210 may also communicate with other connected vehicles over vehicle-to-vehicle (V2V) communications.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with teleoperation execution circuit 210 can include either or both wired and wireless communications circuits 201. Wireless transceiver circuit 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by teleoperation execution circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the teleoperation execution system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation teleoperation execution system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

Communication circuit 201 can be used to transmit and receive information between teleoperation execution circuit 210 and sensors 152, and teleoperation execution circuit 210 and vehicle systems 158. Also, sensors 152 may communicate with vehicle systems 158 directly or indirectly (e.g., via communication circuit 201 or otherwise).

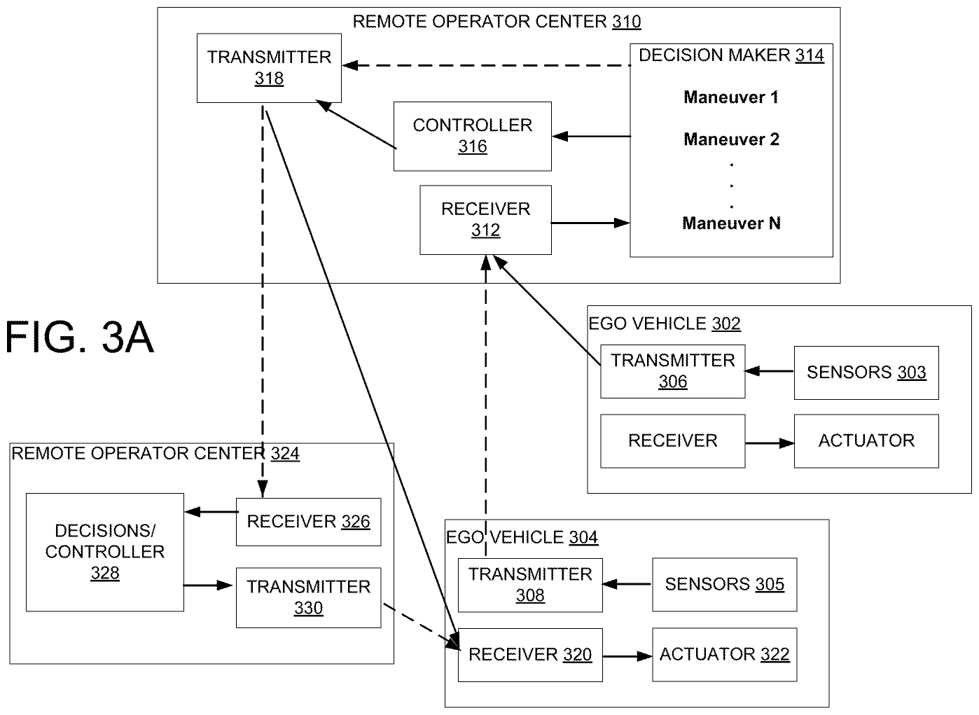

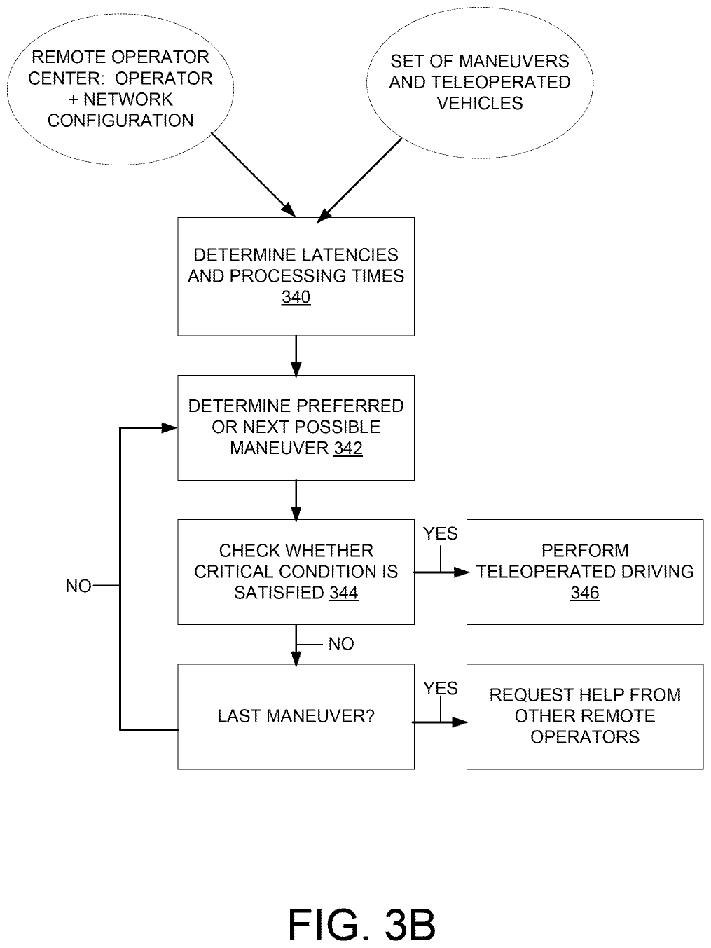

FIG. 3A illustrates an example system for selecting maneuvers for teleoperation of a vehicle. Ego vehicles 302 and 304 may be available vehicles to perform a maneuver from a set of maneuver candidates. Ego vehicles 302 and 304 can transmit a request for assistance, vehicle configurations, maneuver candidates, and sensor data such as image frames or GPS data from transmitters 306 and 308. Sensors 303 and 305 of ego vehicles 302 and 304 can generate this sensor data. This information can be received at remote operator center 310 via receiver 312. In the example of FIG. 3A, remote operator center 310 comprises a transmitter, receiver, controller, and decision maker. In other embodiments, remote operator center 310 can comprise a human operator that receives this information from ego vehicles 302 and 304.

Receiver 312 can transmit this information to decision maker 314. Decision maker 314 can select a maneuver from the maneuver candidates as described further below in FIG. 3B. This selection can be transmitted by controller 316 to transmitter 318. Transmitter 318 can send this maneuver selection to ego vehicle 302 or 304 based on which maneuver is selected. In the example of FIG. 3A, transmitter 318 can send the maneuver selection to ego vehicle 304. Ego vehicle 304 can receive the maneuver selection at receiver 320 and transmit the selection to actuator 322. Actuator 322 can trigger ego vehicle 304's vehicle systems to effectuate the maneuver.

In some cases, remote operator center 310 may require assistance from another remote operator center. In this instance, decision maker 314 can communicate this request for assistance to remote operator center 324 through transmitter 318. Remote operator center 324 can receive the request at receiver 326 and analyze the request at decisions module/controller 328. Similar to decision maker 314, decisions module/controller 328 can select a maneuver as described further below in FIG. 3B. Once a maneuver is selected, the selection can be transmitted to transmitter 330. Transmitter 330 can send this maneuver selection to ego vehicle 302 or 304 based on which maneuver is selected. In the example of FIG. 3A, transmitter 330 can send the maneuver selection to ego vehicle 304. Ego vehicle 304 can receive the maneuver selection at receiver 320 and transmit the selection to actuator 322. Actuator 322 can trigger the vehicle systems to effectuate the maneuver. While the example system in FIG. 3A incorporates two remote operator centers and two ego vehicles, the system can extend to include any number of ego vehicles and remote operator centers. Additional remote operator centers may communicate with each other based on requests for assistance. Additional ego vehicles may be implicated by the set of maneuvers. The selection of a maneuver can correspond to a particular ego vehicle.

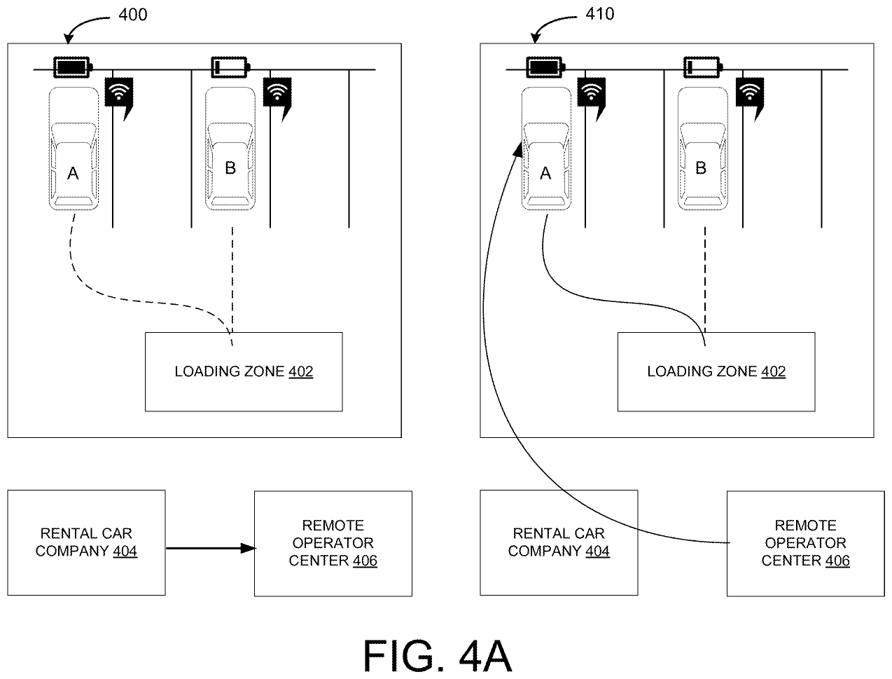

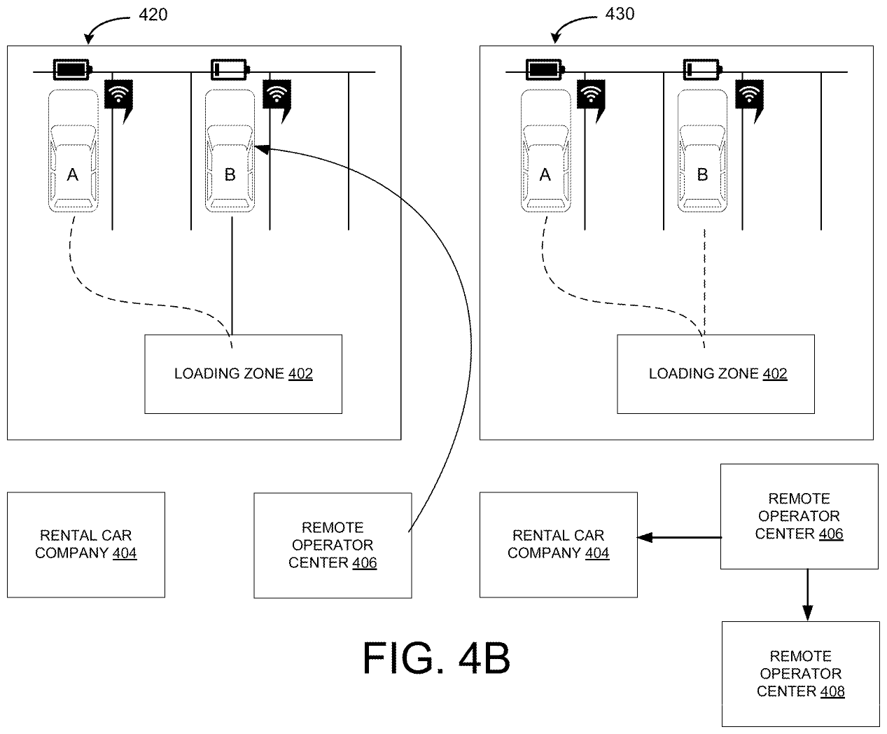

FIG. 3B illustrates an example architecture to be executed by a decision maker at a remote operator center (e.g., decision maker 314). The decision maker can receive information on the remote operator, network configuration, or any parameters of the remote operator center that can affect latencies. The decision maker can also receive the set of maneuvers and specific teleoperated vehicles associated with the set of maneuvers. The set of maneuvers and/or teleoperated vehicles may correspond to a specific use case or task to be completed. In some embodiments, the set of maneuvers may correspond to a particular goal. For example, a goal may be to maneuver a vehicle into a specific parking spot. As another example, a goal may be to clear a row of parking spaces and relocate any vehicles in those spaces. The set of maneuvers can correspond to one or more maneuvers that accomplish the goal. As illustrated below in FIG. 4, an example task can comprise moving a rental vehicle to a loading zone. The specific vehicles may be selected based on user input, predefined selections, or any other information that can be sent to the remote operator center along with the set of maneuvers and teleoperated vehicles. The set of maneuvers can comprise the maneuvers needed to move the specific vehicles to the loading zone. In this example, each maneuver in the set may correspond to an available teleoperated vehicle. In some embodiments, multiple maneuvers may correspond to a single vehicle, or multiple vehicles may have a same or similar maneuver.

At block 340, the decision maker can determine the latencies and processing times. As described above, latencies can refer to anything delaying the actuation of a remote driving maneuver, including, but not limited to, the time to create torque when commanded, the time to assign commands to the vehicle, the processing time for the remote operator, the time to communicate images or other sensor information from the vehicle to the teleoperator, and/or the time to send commands back to the vehicle after transmitting sensor information to the remote operator. Different maneuvers have different tolerances for latency. The system can evaluate relevant properties and parameters of the given remote operator, including the network configuration, type of the operator and the parallel tasks which may occupy the same network channel and remote processor in order to determine these tolerances and latencies. Additionally, the system can analyze the transmitting rates of the uplink and downlink, the processing rate of the remote processor, the vehicle configuration (including actuation time), and multiple maneuver candidates.

At block 342, the system can determine a preferred maneuver from the set of maneuvers. Here, a predefined preference parameter can refer to any preference in selecting a maneuver outside of latency configurations. This preference parameter may be set by a client user for example. Example preferences can include, but are not limited to selecting maneuvers based on the battery or fueling of the corresponding vehicle, type of vehicle, fuel cost, etc. In some embodiments, preferences may be applied first to eliminate certain maneuvers from the set of maneuvers. In other embodiments, preferences can be applied after maneuvers have been found to satisfy the critical condition. Maneuvers may be evaluated first based on the preference parameter. For example, if the preference is to use vehicles with a higher battery charge, a maneuver associated with a vehicle with the highest battery charge may be evaluated first to see if the critical condition is met. The system may move on to the next highest battery charge and so on for evaluating additional maneuvers in the set.

At block 344, the decision maker can check whether the critical condition is satisfied. As described above, the critical condition can refer to a parameter that must be met and can be affected by latency considerations. Example critical conditions can include, but are not limited to, the curvature of a turn, the speed exceeding or meeting a threshold, the path taken, vehicle parameters, or turning radius. The system can ensure the selected maneuver and the evaluated latency satisfies the critical condition before proceeding with the remote operating task. If the selected maneuver meets the critical condition, the decision maker can proceed with performing the remote driving task at 346. If the selected maneuver does not meet the critical condition, the system can repeat steps 342 and 344 to evaluate the other maneuvers in the set. In some embodiments, the system can select a subset of feasible maneuvers to accomplish the goal. Here, a feasible maneuver may correspond to maneuvers that satisfy preferences and/or critical conditions. In some embodiments, a subset can be selected through simulation of the maneuvers, through analysis (i.e. through stability charts indicating the feasibility of maneuvers) through lookup tables including information on various maneuvers, or a combination of those methods. If the subset does not contain any maneuvers, the system may not begin the teleoperated driving task.

In some embodiments, both a preference parameter and the critical condition must be satisfied to perform the teleoperated driving task. In other embodiments, only the critical condition may need to be satisfied to perform the remote driving task. In this instance, maneuvers meeting the preference parameter may be evaluated first to meet the critical condition before analyzing other maneuvers in the set. In some embodiments, the maneuvers in the set cannot satisfy the preference parameter and/or the critical condition. Preference parameters may include time efficiency, comfort, and/or energy efficiency. Preference parameters may be used to select an optimal maneuver to accomplish the goal.

In some embodiments, a maneuver can be selected in real-time. The teleoperated driving task can be evaluated up to a predefined or automatic time horizon. The preference parameter and critical condition may also dynamically change, so these can be evaluated up to the time horizon. The system can dynamically update the set of feasible maneuvers up to the time horizon. If network quality of service or performance indicators change during the time interval to make any maneuvers infeasible, the system may adapt accordingly. In some embodiments, the desired speed and curvature can be decreased for the teleoperated driving task until the maneuvers are feasible. In some embodiments additional assistance may be requested, described further below. Alternatively or in addition, a minimal risk maneuver may be selected and performed to end the teleoperated driving task and have the vehicle sit in a safe location until further notice.

At block 348, if there are no other maneuvers to evaluate, the system can request help from other remote operators at block 350. Other remote operators may be able to satisfy the critical condition for a maneuver in the set of maneuvers. For example, the first remote operator center may be congested with multiple simultaneous remote driving tasks. As a result, the remote operator center may have higher latencies and may not be able to perform the set of maneuvers if the maneuvers all have a low tolerance for latency based on the critical condition. In contrast, the other remote operator center may not be as congested and may have lower latencies such that it can meet the low tolerances. The other remote operator center may be more equipped to perform the remote operating task in the current situation. The system can request assistance from as many additional remote operators as needed.

FIG. 4A illustrates an example scenario incorporating the system described in FIGS. 3A and 3B. In this case, the remote operating task is moving a vehicle to a loading zone. As illustrated at block 400, vehicles A and B have certain paths leading to loading zone 402. Vehicles A and B may be the same type of rental car with varying levels of battery status. As illustrated at block 400, vehicle A is fully charged, and vehicle B is low on battery. The rental car company can send a request to move one of the vehicles to the loading zone in front of the building, so that the customer can drive the rental car away without searching for the car. A rental company 404 can provide both paths to remote operator center 406 and mark the preference of the candidates. For example, vehicle A may be preferable because it has a higher battery charge. The maneuvers associated with these different paths may have different maximum allowed latencies. The maneuver of moving vehicle A may include a lower latency tolerance since it involves more steering compared to moving vehicle B.

At block 410, remote operator 406 can select the vehicle and the path based on vehicle information and the network and remote operators' availability/capability. Each choice can be associated with a maximum allowed latency. As illustrated in block 410, if the network and the remote operator's condition is good, (i.e., the end-to-end latency is smaller than the maximum allowed latency for both candidates), remote operator center 406 may choose to move vehicle A to the loading zone since it is preferred by the rental car company. This selection can be used to teleoperate vehicle A. After the operation is completed, remote operator center 406 will notify rental car company 404 and the customer can leave with the vehicle.

FIG. 4B illustrates additional scenarios that may occur instead of that illustrated in block 410. At block 420, the network and the remote operator's condition may not be sufficient, i.e., the end-to-end latency may be larger than the allowed latency of one of the maneuvers, but still smaller than the other. In this case, remote operator center 406 can choose to move vehicle B to loading zone 402. In the case of block 420, vehicle A cannot be operated safely due to the current network and remote operator's condition. Instead, vehicle B can be moved because the associated maneuver has a larger latency tolerance. The selection can be used to teleoperate vehicle B. After the operation is completed, remote operator center 406 can notify rental car company 404 and the customer can leave with the vehicle.

At block 430, it is possible that neither of the maneuver candidates can be safely executed. In this case, primary remote operator center 406 can request help from remote operator center 408 to perform one of the maneuvers, as mentioned previously in FIG. 3B. In some cases, remote operator center 408 can have a better network condition and/or a more powerful remote controller. Remote operator center 408 can run the same decision analysis and select either vehicle A or vehicle B based on its own latency determinations. Remote operator center 408 can teleoperate the selected vehicle and move the vehicle to the loading zone. Remote operator center 406 can communicate this assistance to rental car company 404 and notify the company when the maneuver is successful.

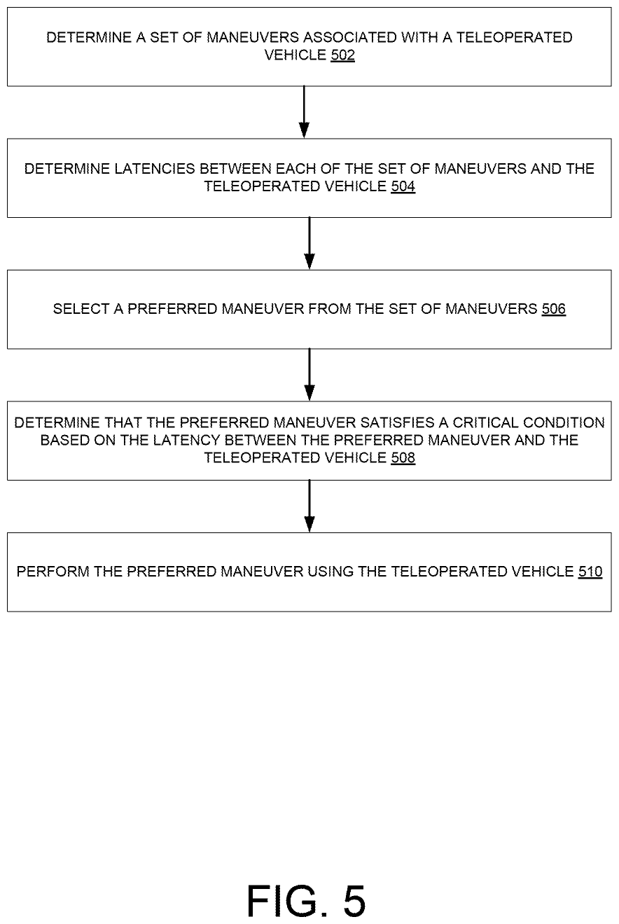

FIG. 5 illustrates an example method incorporating the systems described above. At block 502, the system can determine a set of maneuvers associated with a teleoperated vehicle. As described above, the decision maker can receive information on the remote operator, network configuration, or any parameters of the remote operator center that can affect latencies. The decision maker can also receive the set of maneuvers and specific teleoperated vehicles associated with the set of maneuvers. The set of maneuvers and/or teleoperated vehicles may correspond to a specific use case or task to be completed. The specific vehicles may be selected based on user input, predefined selections, or any other information that can be sent to the remote operator center along with the set of maneuvers and teleoperated vehicles. In some embodiments, each maneuver in the set may correspond to an available teleoperated vehicle. In some embodiments, multiple maneuvers may correspond to a single vehicle, or multiple vehicles may have a same or similar maneuver.

At block 504, the system can determine latencies between each of the set of maneuvers and the teleoperated vehicle. As described above, latencies can refer to anything delaying the actuation of a remote driving maneuver, including, but not limited to, the time to create torque when commanded, the time to assign commands to the vehicle, the processing time for the remote operator, the time to communicate images or other sensor information from the vehicle to the teleoperator, and/or the time to send commands back to the vehicle after transmitting sensor information to the remote operator. Different maneuvers may have different tolerances for latency. Additionally, the system can evaluate relevant properties and parameters of the given remote operator, including the network configuration, type of the operator and the parallel tasks which may occupy the same network channel and remote processor in order to determine certain latencies.

At block 506, the system can select a preferred maneuver from the set of maneuvers. As described above, the system can evaluate whether a remote driving maneuver satisfies a predefined preference parameter. Here, a predefined preference parameter refers to any preference in selecting a maneuver outside of latency configurations. This preference parameter may be set by a client user for example. Example preferences can include, but are not limited to selecting maneuvers based on the battery or fueling of the corresponding vehicle, type of vehicle, fuel cost, etc.

At block 508, the system can determine that the preferred maneuver satisfies a critical condition based on the latency between the preferred maneuver and the teleoperated vehicle. As described above, the critical condition can refer to a parameter that must be met and can be affected by latency considerations. The system can make sure the selected maneuver and the evaluated latency satisfies the critical condition before proceeding with the remote operating task. In some embodiments, the maneuver must satisfy both the predefined preference parameter and the critical condition. In other embodiments, maneuver only needs to satisfy the critical condition. At block 510, the system can perform the preferred maneuver using the teleoperated vehicle.

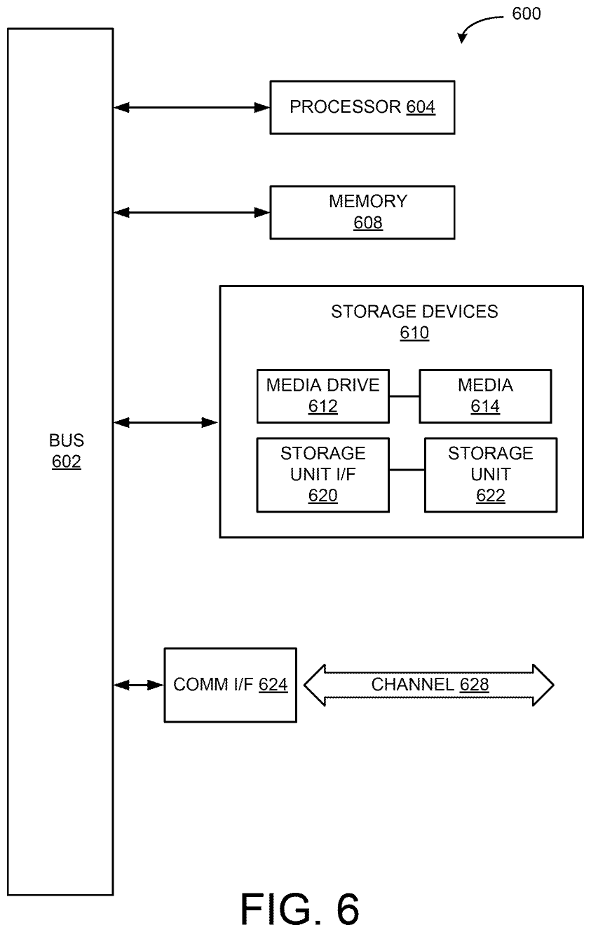

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or another interface). Other examples include a communications port (such as for example, a USB port, IR port, RS232 port Bluetooth® interface, or other port), or another communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining a set of maneuvers associated with a teleoperated vehicle;
determining latencies between each of the set of maneuvers and the teleoperated vehicle;
selecting a preferred maneuver from the set of maneuvers;
determining that the preferred maneuver satisfies a critical condition based on the latency between the preferred maneuver and the teleoperated vehicle; and
performing the preferred maneuver using the teleoperated vehicle.

2. The method of claim 1, wherein determining latencies is based on an actuation time for the teleoperated vehicle.

3. The method of claim 1, wherein determining latencies comprises determining uplink latencies, downlink latencies, and processing time for each of the set of maneuvers.

4. The method of claim 3, wherein the processing time includes a remote operator reaction time.

5. The method of claim 1, wherein the critical condition comprises path, curvature, speed, or vehicle parameters.

6. The method of claim 1, wherein selecting the preferred maneuver is based on a predefined preference parameter.

7. The method of claim 6, wherein the predefined preference parameter is set based on user input.

8. The method of claim 6, wherein the predefined preference parameter comprises fueling or battery charge.

9. A system for remote teleoperation of a vehicle, comprising:
a processor; and
a memory coupled to the processor to store instructions, which when executed by the processor, cause the processor to:
determine a set of maneuvers associated with a teleoperated vehicle;
determine latencies between each of the set of maneuvers and the teleoperated vehicle;
select a preferred maneuver from the set of maneuvers based on a predefined preference parameter;
determine that the preferred maneuver does not satisfy a critical condition based on the latency between the preferred maneuver and the teleoperated vehicle;
select a next preferred maneuver from the set of maneuvers based on the predefined preference parameter; and
perform the next preferred maneuver using the teleoperated vehicle.

10. The system of claim 9, wherein determining latencies is based on an actuation time for the teleoperated vehicle.

11. The system of claim 9, wherein determining latencies comprises determining uplink latencies, downlink latencies, and processing time for each of the set of maneuvers.

12. The system of claim 11, wherein the processing time includes a remote operator reaction time.

13. The system of claim 9, wherein the critical condition comprises path, curvature, speed, or vehicle parameters.

14. The system of claim 13, wherein the predefined preference parameter is set based on user input.

15. The system of claim 13, wherein the predefined preference parameter comprises fueling or battery charge.

16. A non-transitory machine-readable medium having instructions stored therein, which when executed by a processor, cause the processor to:
determine a set of maneuvers associated with a teleoperated vehicle;
determine latencies between each of the set of maneuvers and the teleoperated vehicle;
select a preferred maneuver from the set of maneuvers based on a predefined preference parameter;
determine that the preferred maneuver does not satisfy a critical condition based on the latency between the preferred maneuver and the teleoperated vehicle;
determine that no other maneuvers in the set of maneuvers satisfy the predefined preference parameter; and
request assistance from a remote operator to operate the teleoperated vehicle.

17. The non-transitory machine-readable medium of claim 16, wherein determining latencies comprises determining uplink latencies, downlink latencies, and processing time for each of the set of maneuvers.

18. The non-transitory machine-readable medium of claim 17, wherein the processing time includes a remote operator reaction time.

19. The non-transitory machine-readable medium of claim 16, wherein the critical condition comprises path, curvature, speed, or vehicle parameters.

20. The non-transitory machine-readable medium of claim 19, wherein the predefined preference parameter comprises fueling or battery charge.
